(19) United States
(12) Patent Application Publication
(10) Pub. No.: US 2012/0188286 A1
(43) Pub. Date: Jul. 26, 2012

(54) DYNAMIC IMAGE TILING

(75) Inventors: Rasmus Groth, Copenhagen NV (DK); Asbjoern Sloth Toennesen, Broenshoej (DK); Manolo Oliver Folcarelli, Copenhagen V (DK); Jonas Tesch Hallberg, Copenhagen N (DK); Joshua Sills Gottdenker, Copenhagen K (DK); Tor Kristensen, Copenhagen NV (DK); Clifford Lee Hall, Jonesborough, TN (US)

(73) Assignee: LILA APS (AHEAD.), Copenhagen N (DK)

(21) Appl. No.: 13/131,554

(22) PCT Filed: Nov. 27, 2009
(86) PCT No.: PCT/US09/66029

§ 371 Date: Aug. 17, 2011

Related U.S. Application Data
(60) Provisional application No. 61/118,121, filed on Nov. 26, 2008.

(51) Int. Cl. G09G 5/373

(52) U.S. Cl. 345/670

(57) ABSTRACT

A system and method of manipulating digital images to optimize for quick viewing of details, and is related to companion applications filed simultaneously, all of which are part and parcel to a method for browsing digital content and composing digital media and data, via dynamic interaction of tiled images, external video, audio, text, and multimedia resources to create smoother and faster response time to user request, managed by a level of detail system which expands the ability of user to create, manipulate, and interact with digital content and media via an application hosted in a browser or running on a desktop application which enhances user ability to dynamically position and zoom into and out of views within a larger canvas.

### RELATED APPLICATIONS

The instant application is related to and claims priority from U.S. Provisional Application 61/118,121, filed Nov. 26, 2008, titled “Content-Context Browser” and is also related to application titled, “Dynamic Level of Detail (LoD)” and application titled, “Dynamic Network Browser,” each filed on the same date, to the same inventors, and all of which are hereby incorporated by reference herein in their entirety.

### BACKGROUND

One or more embodiments of the present invention relates to a system and method of manipulating digital images to optimize for quick viewing of details, and is related to companion applications filed simultaneously, all of which are part and parcel of a method of browsing digital content and composing digital media and data, via dynamic interaction of tiled images, external video, audio, text, and/or multimedia resources to create smoother and faster response time to user request, managed by a level of detail system which expands the ability of user to create, manipulate, and/or interact with digital content and media via an application hosted in a browser or running on a desktop application which enhances user ability to dynamically position and zoom into and out of views within a larger canvas.

Use of zoom is common in graphics software to enhance and work with details in digital images, for example, and to present an overview of the images.

A disadvantage of some zoom programs is that the user must wait for the download of an entire image before it is available to view. Programs such as Silverlight download only the area in view, optimized for the zoom level being viewed. This feature of downloading only the area in view is also known from Google Earth. The Microsoft Silverlight application, in which the program DeepZoom is enabled, aligns adjacent images to “build” and create one new image, technology providing the user with the impression of zooming in on the original collage of images. However, the images are just passive, not dynamic. DeepZoom does not provide an effective way of utilizing the depth provided by true zooming, such as with optical zoom technology.

Further, in conventional tiling processes a file is decompressed, cut, scaled, compressed and saved, a process which does not enable an application to process only the necessary part of the image on demand if the total image has not yet been processed.

### SUMMARY

A vital aspect of the invention is the dynamic nature of tiling, which enables a client application to request a specific tile with the result that the particular tile requested is placed first in the cue, enabling the user to obtain and view sought after content more quickly. This method differs from other methods of zooming, which tile an entire image before any portion of the tiles are available for viewing.

### BACKGROUND AND DEFINITIONS

By one or more embodiments of the present invention it is possible to interrupt the “conventional ” sequential tiling process, avoiding that the server has to open, decompress and save the original uploaded image for each version of the image needed. By this invention, the original file only has to be opened once.

The advantage of at least on embodiment of the invention compared to conventional tiling processes is that it reduces the span of time from the moment when an image is uploaded to the server and the server is ready to deliver tiled images to the client. Based on at least this improvement, users can quickly and smoothly zoom within the uploaded image immediately after it has uploaded.

Further, one or more embodiments of the invention can prioritize the tiling processing of the most relevant image tiles based on the user's current zoom level and position in the space, and depending on client requests on certain tiles. For example, if a tile is requested by one or more clients this tile will be processed and delivered to the requesting clients before other non-requested tiles are processed. This will also contribute to users having a smooth zoom experience, even though all the tiles have not yet been processed.

### Term List

Frame—A named, 2-dimensional digital virtual canvas of potentially infinite Extent within which digital content (media items such as images, movies and animations) can be placed in any arrangement the user desires. A frame can be seen as the equivalent of an infinitely large table or whiteboard whereon content can be placed and manipulated freely, for example by means of a pointing device.

Extent—The smallest rectangular region that bounds all content arranged and presented within a frame, i.e. the area of the virtual canvas that is full of content.

Space—a subset of a frame.

Scene—A named, finite rectangular area within the coordinate system of a Space. A view port of fixed size that relates to the viewable area of the frame on a physical display screen.

Network Browser—a navigable network of visually connected nodes representing relations (permission, contextual) between spaces, projects, and users. The level of detail available in the Network Browser is dependent on the level of access and permissions assigned to the active user account.

Space Client—A multi-user software environment allowing users to alone or collaboratively view or modify the contents of a space, and create or navigate from scene to scene within a space.

Node—An iconic representation of a space, project or user displayed within the Network Browser.

Application—A computer software program.

Modular Application—An application whose functionality is distributed across a set of applications.

Client—An application which runs on a user's computer and occasionally communicates with one or more servers or other clients via an internet connection.

Server—An application that responds to requests from individual clients, occasionally interacting with a database to store and retrieve information on behalf of the client. A server application may also facilitate the communications between clients.

### PNG Files

Portable Network Graphics (PNG) is a bitmapped image format that employs lossless data compression. PNG supports palette-based (palettes of 24-bit RGB colors), greyscale or RGB images. PNG was designed for transferring images on the Internet, not professional graphics, and so does not support other color spaces (such as CMYK). A PNG file is a compressed bitmap, therefore each pixel has a certain length. With a 3×3 pixel image the pixels would be sequentially placed right after each other and would look like this: [1,1][2,1][3,1][1,2][2,2][3,2][1,3][2,3][3,3] with [x,y] being a pixel of a fixed byte length, dependent on the palette size and other options. Because of the fixed byte length of each pixel, it is fast to calculate the memory address of a specific pixel.

### Tiling

Tiling is a method of dividing large images into smaller pieces resembling and called tiles, to enable an application to load and display only parts of an image, thus lowering bandwidth, ram and CPU useage. Tiling is often found and used in mapping applications such as GoogleEarth.

### BRIEF DESCRIPTION OF THE DRAWINGS

FIG. 1 illustrates processes to create and prioritization tiled bitmap images,

FIG. 2 illustrates an example of generating a tile,

FIG. 3 illustrates an example of tiling an image,

FIG. 4 is the mathematical equation from the process in FIG. 3,

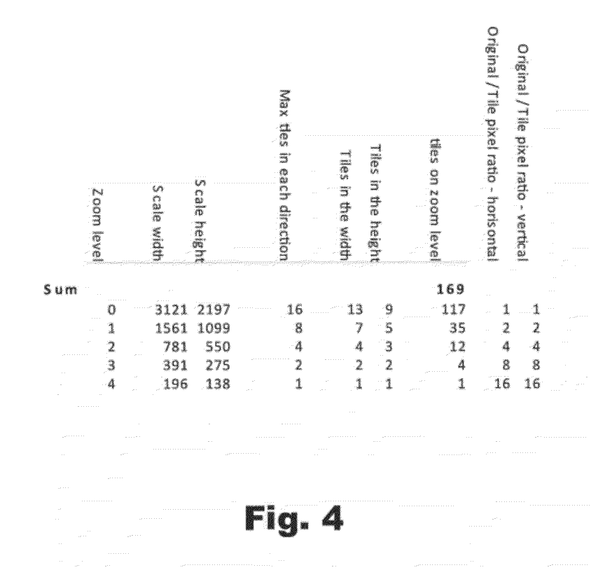

FIG. 5 is a block diagram of a computer system usable in conjunction with an embodiment,

FIG. 6 depicts flow charts of tiling and compressing processes, and

FIG. 7 is a depiction of scale version calculation according to an embodiment.

### DETAILED DESCRIPTION

An object of an embodiment of the invention is to provide zooming functionality with minimal wait time, allowing for a speedy, effective, and smooth experience for the user. In at least one embodiment, zooming in a frame is an important feature.

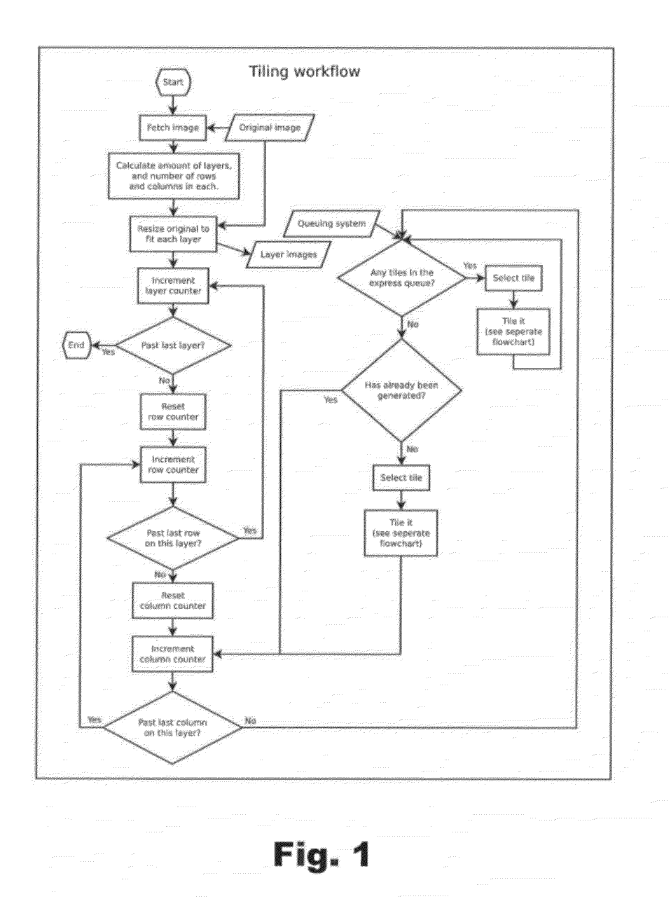

This type of zooming functionality is achieved by enabling a client application to request, and a server to queue for rendering a specified tiled segment or segments of an image from a dynamically created database of tiled bitmap versions of a digital image, which database is established by creating tiled bit map images from a number of complete versions of an image, each complete version made sequentially smaller until the complete image can be enclosed within one tile. FIG. 1 illustrates the logical processes required to generate, store and serve tiled bitmap data, while also prioritizing specific tiles in the process queue in response to requests made for bitmap data.

One purpose of the above-mentioned method is to create several versions of the same image corresponding to different zoom levels of the image, thus also corresponding to different resolutions of the image, and likewise corresponding to different sizes of the image. In one embodiment, zoom level 0 is associated with the original resolution of the image, zoom level 1 is associated with a version of the image with reduced resolution, zoom level 2 is associated with a version of the image with even further reduced resolution, and so on. Each version of the image is tiled, meaning each version of the image is divided into a plurality of equally sized tiles. In the preferred embodiment, the size of the tiles is predefined. Preferably, the same size tile is used for each version of the image.

The method applies directly to bitmap images and also compressed bitmap images, such as PNG files. In one embodiment of the invention, the process starts with creating a bitmap of the digital image if not already provided in the bitmap format.

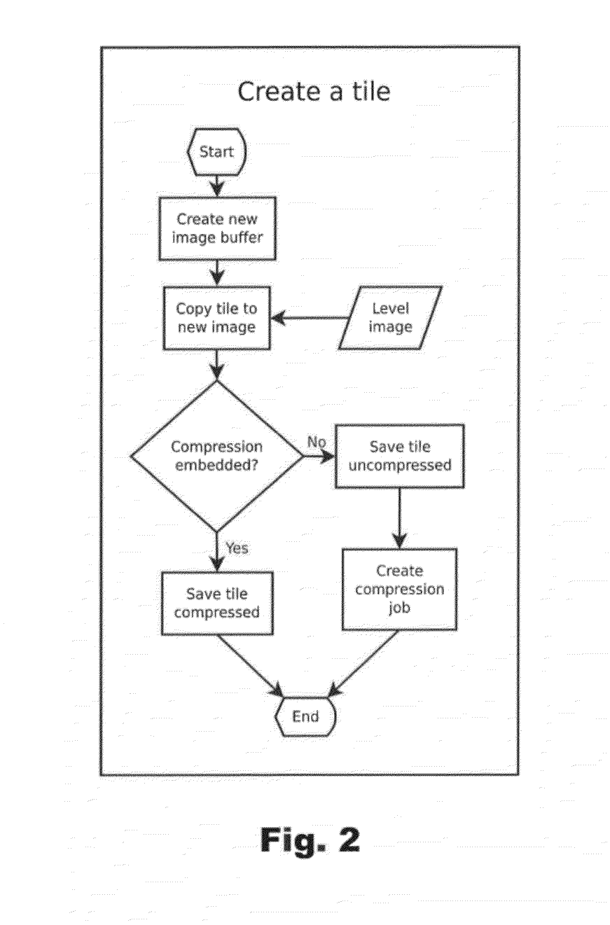

This first bitmap version of the digital image is then divided into tiles. FIG. 2 illustrates the logical process required to generate a single tile from a bitmap image. A second bitmap version of the digital image is then created by reducing the size and resolution of the first bitmap version of the digital image. This second bitmap version is then tiled. The second bitmap version of the digital image is then reduced in size to create a third bitmap version of the digital image, and this third bitmap version is subsequently tiled. This size-reduction-and-tiling process continues until a reduced size bitmap version of the digital image is encloseable by a single tile. Thereby, a number of sequentially smaller tiled bitmap versions of a digital image have been created.

In at least some embodiments of the invention, the image size is reduced by a factor of two in each step.

The tiles are, preferably, quadratic. In one embodiment of the invention the size of the tiles are 16×16 pixels, 32×32 pixels, 64×64 pixels, 128×128 pixels, 256×256 pixels, 512×512 pixels, or 1024×1024 pixels.

In at least some embodiments, when tiling a bitmap version of the image, if the image does not fill an integer number of tiles, transparent pixels are inserted into empty parts of tiles in the tiled bitmaps, in order that the image comprises an integer number of tiles in each tiled bitmap.

One embodiment of the invention is a method for dividing a bitmap image into a number of tiled bitmaps, wherein each tile has the same size and a predefined number of pixels, said method comprising the steps of:
a) determining the number of tiled bitmaps based on the minimum pixel dimension in the tiles and the maximum pixel dimension in the image,
b) creating a tiled bitmap of the image by dividing the image into equally sized tiles,
c) downsizing the image,
d) creating a tiled bitmap of the downsized image by cutting said downsized image into equally sized tiles, and
e) repeating steps c) to d) with the downsized image by repeatedly downsizing until the minimum pixel dimension in the tiles is greater than or equal to the 5 maximum pixel dimension in the downsized image.

The number of tiled bitmaps, or “Nbm,” created can be determined beforehand. In the case where the resolution of each bitmap version is reduced by a factor of two in each step, the following formula applies:

Nbm=RoundUp(log2(Bmdim_max))−(Log2(Tidim_min)−1),

wherein RoundUp rounds up to nearest integer, log2 is the logarithmic function with base 2, Bmdim_max is the maximum pixel dimension in the image, and Tidim_min is the minimum pixel dimension in the tiles.

This formula only applies to images where Bmdim_max is larger than half the size of Tidim_min. In other cases. Nbm should be 1, but often such images would not be tiled.

The plurality of tiled bitmaps and each tile in each tiled bitmap are stored, preferably separately, in at least one database, along with metadata informing of the width and height of the original image.

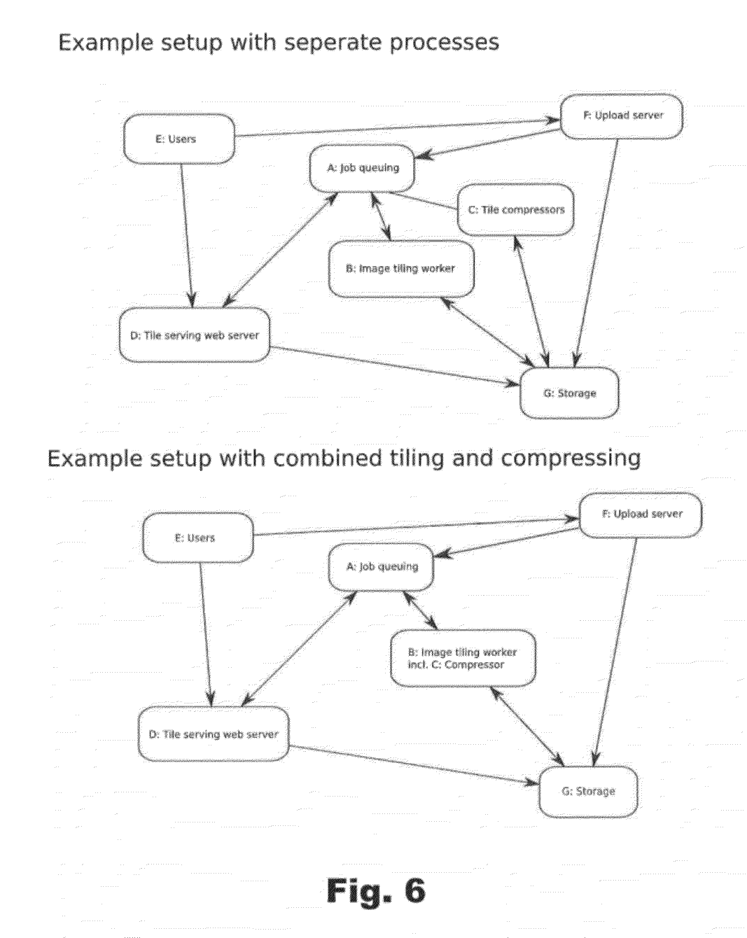

One embodiment of this invention comprises four elements:
1. A queuing system for handling the tiling queue and communicating with the other processes, (A in FIG. 6),
2. a number of tiling processes, (B in FIG. 6),
3. a number of compressor processes for compressing the tiles from the tiling processes, which is an element that may be embedded in the tiling process, (C in FIG. 6), and
4. a web server for tile serving which communicates with one or more queuing processes. (D in FIG. 6).

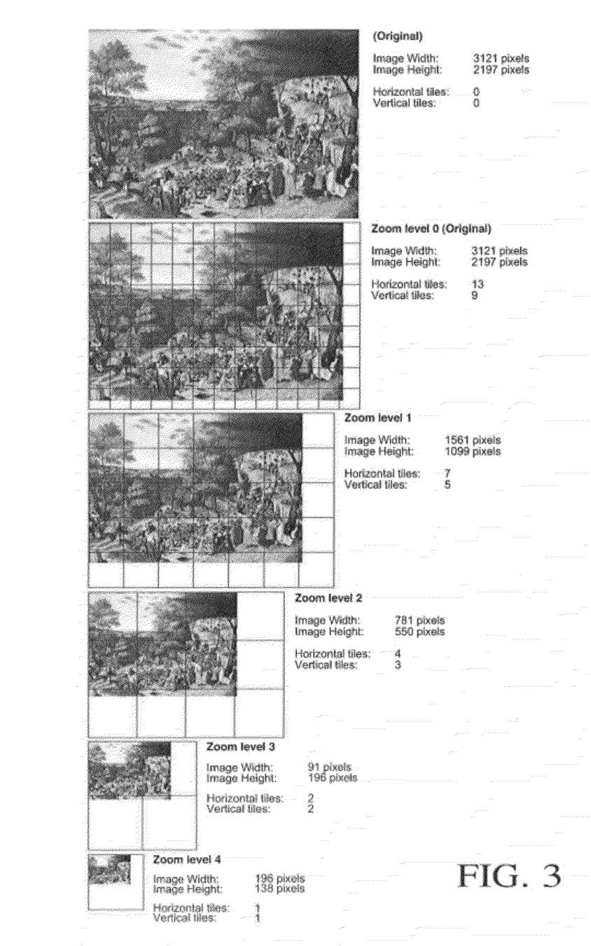

FIG. 3 illustrates an example of tiling an image. The top image is the original digital image that is to be tiled. In this case, the image width is 3121 pixels, and the image height is 2197 pixels. The next image from the top shows the image divided in tiles. Each tile is 256×256 pixels providing 13 tiles in a horizontal row and 9 tiles in a vertical column, a total of 117 tiles to cover the image. It is shown that tiles in the bottom row and tiles in the right column are not completely filled. At each zoom level, empty areas of these tiles are filled, preferably, with transparent pixels. In the third image from the top, the original image has been reduced in size by a factor of 2. Thereby, this third image width is 1561 pixels, and the image height is 1099 pixels, requiring 35 tiles (256×256 pixels) to cover this image. This image is further reduced in size by a factor of two, providing the fourth image from the top having a width of 781 pixels, and a height 550 pixels and being covered by 12 tiles. Once more, reduction in size by a factor of two provides the fifth image from the top, having a width of 391 pixels, a height 275 pixels, and being covered by 4 tiles. The last size reduction by a factor of 2 provides the bottom image, having a width of 196 pixels, and a height 138 pixels. This image is encloseable by one tile, prompting an end to the tiling process.

After the process just described, the original image is associated with 5 image copies of sequentially smaller size. This corresponds to zoom levels 0, 1, 2, 3 and 4, which is obvious when studying FIG. 3: Going from the bottom image “Zoom level 4,” to the second image from the top “Zoom level 0,” is like zooming in on the original image. Furthermore, each of the images has been tiled, and a total of 117+35+12+4+1=169 tiles are associated with the original image. Thereby, applications or services requesting part of the image from, for example, a server do not have to receive the entire image, but only the part incorporating their request.

The number of versions of the image that are produced by this tiling process is calculable in advance. The formula provided previously is applicable can be applied to the above-mentioned example:

N_{bm}=RoundUp(log2(Bm_{dim}_{_{—}}ₘₐₓ))−(Log2(Ti_{dim}_{_{—}}ₘᵢₙ)−1),

wherein RoundUp rounds up to nearest integer,
log2 is the logarithmic function with base 2,
Bm_{dim}_{_{—}}ₘₐₓ is the maximum pixel dimension in the image, and
Ti_{dim}_{_{—}}ₘᵢₙ is the minimum pixel dimension in the tiles.
In this example, Bm_{dim}_{_{—}}ₘₐₓ is 3121 pixels and Ti_{dim}_{_{—}}ₘₘ is 256 pixels, so N_{bm}=RoundUp(log2(3121))−(Log2(256)−1)=5.

Thus, five versions of the image corresponding to zoom levels 0, 1, 2, 3 and 4 are produced. The web server looks for the compressed tile, e.g. on a distributed file system. If the compressed tile does not exist, the server calls a runtime handler, which then checks if the tile is available uncompressed. If the tile is unavailable compressed or otherwise, the request is provided with a higher priority in the queuing system, which can respond either by fast processing of the tile and returning it; that the tile cannot be delivered; or that the server should wait a predetermined number of milliseconds, and then ask again.

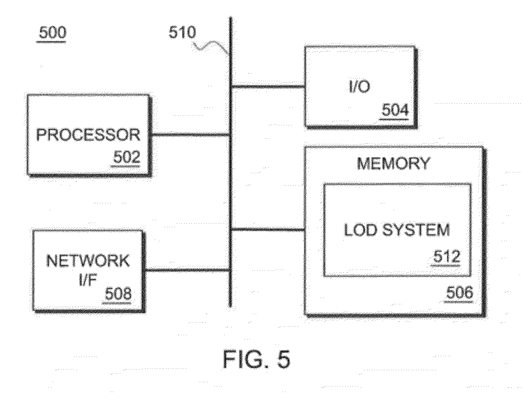

FIG. 5 depicts a high-level functional block diagram of a computer systems (500) usable in conjunction with an embodiment. Computer systems 500 comprises a processor 502 (alternatively referred to as a processing or controller-based device), a memory 506, a network interface (I/F) 508, and an storage input/output device 504 communicatively coupled via a bus 510 or other interconnection communication mechanism.

In at least some embodiments, memory 506 also stores a set of executable or interpretable instructions, e.g., the tiling algorithms 512, which, when executed or interpreted by the processor, cause the processor to perform a method according to an embodiment of the invention. In at least some embodiments, execution by processor 502 of the executable instructions causes the display of a user interface to a user of computer system 500 via network I/F 508.

Network I/F 508 comprises a mechanism for connecting to a network.

In at least some embodiments, computer system 500 comprises more than a single network interface. In at least some embodiments, network I/F 508 may comprise a wired and/or wireless connection mechanism.

Optionally A storage device 504, such as a magnetic disk, optical disk, electromagnetic disk or flash memory may be provided and coupled to the bus 510 for storing data and/or instructions. If 512 assembles element G from FIG. 5 then a storage device 504 is required.

An I/O device comprising an input device, an output device and/or a combined input/output device for enabling user interaction. An input device may comprise, for example, a keyboard, keypad, mouse, trackball, trackpad, and/or cursor direction keys for communicating information and commands to processor 502. An output device may comprise, for example, a display, a printer, a voice synthesizer, etc. for communicating information to a user. In at least some embodiments, I/O device may comprise a serial and/or parallel connection mechanism for enabling the transfer of one or more of files and/or commands. In at least some embodiments, I/O device may comprise a firewire (IEEE1394) bus and/or a Universal Serial Bus (USB). An I/O device may optionally be coupled to the bus 510 for storing data and/or instructions.

Memory 506 (also referred to as a computer-readable medium) may comprise a random access memory (RAM) or other dynamic storage device, coupled to the bus 510 for storing data and/or instructions to be executed by processor 502. Memory 506 also may be used for storing temporary variables or other intermediate information during execution of instructions to be executed by processor 502. Memory 506 may also comprise a read only memory (ROM) or other static storage device coupled to the bus 510 for storing static information and instructions for the processor 502.

One example set of instructions stored in memory 506 is an LODSystem 512, according to an embodiment. In at least one embodiment, at least one of A, B, C, D, F or G from FIG. 6 are included in LoD System 512. However more than one can be contained in LoD System 512 in a at least one embodiment.

FIG. 6 illustrates the communication pattern of the different elements of the tiling system.

The arrows in the illustrations are pointing away from the initiator of the messages, not necessarily the initiator, and the bidirectional arrows are represent long lived persistent connections.

The illustrated elements are:
(A) Job queuing system
   Responsible for managing the queue, and telling the worker processes
   what to do, and prioritizing the jobs.
(B) Tiling worker
   Responsible for doing the actual image subdivision.
(C) Tile compression
   Responsible for compressing the image bitmaps data.
(D) Tile serving web server
   Responsible for serving the tiles to the end user.
(E) End users
   Users uploading content, and requesting tiles.
(F) Upload server
   Server on the backend receiving uploads from the end user.
(G) Storage system
   In at least some embodiments, this is, for example a distributed storage system,
   or an NFS exported volume.

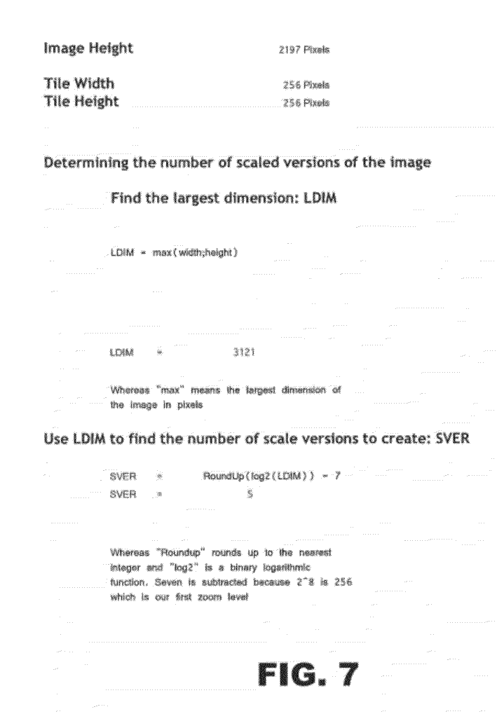

FIG. 7 is a depiction of a scale version calculation according to an embodiment.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A method of creating a number of sequentially smaller tiled bitmap versions of a digital image by repeatedly
dividing said digital image into equally sized tiles, and
reducing the size of the image, until the image is encloseable by one tile.

2. A method according to claim 1, wherein the digital image is a compressed bitmap image, such as a PNG file.

3. A method according to claim 1, wherein the tiles comprise a predefined number of pixels.

4. A method according to claim 1, wherein the tiles are quadratic.

5. A method according to claim 4, wherein the size of the tiles are (16×16 pixels), (32×32 pixels), (64×64 pixels), (128×128 pixels), (256×256 pixels), (512×512 pixels), or (1024×1024 pixels).

6. A method according to claim 1, wherein the size of the images is repeatedly reduced by a factor of two.

7. A method according to claim 3, wherein transparent pixels are inserted into empty parts of tiles in the tiled bitmaps, to fill an integer number of tiles in each tiled bitmap.

8. A method according to claim 10, wherein each tiled bitmap and each tile in each tiled bitmap are stored in at least one database.

9. A method for dividing a digital image into a number of tiled bitmaps, by transforming the digital image into a bitmap image and applying the method according to claim 1.

10. A method for distributing the tiles of at least one image, whereby:
at least one master process is handling at least one tiling queue;
at least one tiling process for dividing the image or images into tiles according to claims 3;
a compressor processes for condensing the tile or tiles from at least one tiling process; and,
the handling a web server for communicating with a plurality of master processes and for serving tiles by request.

11. An article of manufacture comprising a system and apparatus for creating a number of sequentially smaller tiled bitmap versions of a digital image by repeatedly
dividing said digital image into equally sized tiles, and
reducing the size of the image, until the image can be enclosed by one tile.

12. An article of manufacture comprising a system and apparatus according to claim 11, wherein the digital image is a compressed bitmap image, such as a PNG file.

13. An article of manufacture comprising a system and apparatus according to claim 11, wherein the tiles comprise a predefined number of pixels.

14. An article of manufacture comprising a system and apparatus according to claim 11, wherein the tiles are quadratic.

15. An article of manufacture comprising a system and apparatus according to claim 14, wherein the size of the tiles are (16×16 pixels), (32×32 pixels), (64×64 pixels), (128×128 pixels), (256×256 pixels), (512×512 pixels), or (1024×1024 pixels).

16. An article of manufacture comprising a system and apparatus according to claim 11, wherein the size of the images is repeatedly reduced by a factor of two.

17. An article of manufacture comprising a system and apparatus according to claim 13, wherein transparent pixels are inserted into empty parts of tiles in the tiled bitmaps, to fill an integer number of tiles in each tiled bitmap.

18. An article of manufacture comprising a system and apparatus according to claim 11, wherein each tiled bitmap and each tile in each tiled bitmap are stored in at least one database.

19. An article of manufacture comprising a system and apparatus for dividing a digital image into a number of tiled bitmaps, by transforming the digital image into a bitmap image and applying the method according to claim 11.

20. An article of manufacture comprising a system and apparatus for distributing the tiles of at least one image, whereby:
at least one master process is handling at least one tiling queue;
at least one tiling process for dividing the image or images into tiles according to claims 13;
a compressor processes for condensing the tile or tiles from at least one tiling process; and,
the handling a web server for communicating with a plurality of master processes and for serving tiles by request.
